(19) United States
(12) Patent Application Publication
(10) Pub. No.: US 2001/0042033 A1
(43) Pub. Date: Nov. 15, 2001

(54) Automatic stock sell/stop monitor process

(76) Inventor: J. Michael Sposito, Mansfield, OH (US)

Correspondence Address: Emerson & Associates, 4421 Ranchwood Spur, Akron, OH, 44333-1343, US

(21) Appl. No.: 09/758,094

(22) Filed: Jan. 10, 2001

Related U.S. Application Data
(60) Provisional application No. 60/176,096, filed on Jan. 14, 2000.

(51) Int. Cl. G06F 17/60

(52) U.S. Cl. 705/35; 340/825.26

(57) ABSTRACT

A new and improved process for monitoring and modifying a security such that a security owner may have an order price automatically updated without an need for human input. The process includes the steps of includes the steps of providing an associated security having an associated purchase price, setting a sell/stop price, setting variable points, setting a time interval, updating an associated last sale price of the associated security after every time interval, adding the variable points to the associated purchase price, the addition rendering a result, subtracting the result from the associated last sale price, the subtraction rendering an adjustment factor, and creating a new sell/stop price if the adjustment factor is greater than zero by subtracting the adjustment factor from the associated last sale price.

This application claims priority from U.S. Provisional Patent application Ser. No. 60/176,096, entitled AUTOMATIC STOCK SELL/STOP MONITOR PROCESS, filed on Jan. 14, 2000.

### I. BACKGROUND OF THE INVENTION

A. Field of the Invention

This invention relates to the art of buying and selling securities, and more particularly to the art of buying and selling securities via the Internet, and even more particularly to the art of automatically monitoring the sell stop order process.

B. Description of the Related Art

The present invention provides a new and improved process for monitoring stop orders. It is well known in the securities trading field that stop orders and limit orders may be placed on securities. The owner of the security can specify that the security be sold at a predetermined price either above or below the current market price.

However, the owner must monitor the activity of the security during trading hours and, in the event of rising prices, raise his sell stop price to preserve any gains made during the day. This is a time consuming and demanding process requiring constant attention to both the portfolio and the market activity.

This invention is simple in design, effective in use, and overcomes the full growing difficulties and others while providing better and more advantageous overall results.

### II. DEFINITIONS

Buy/Limit order—an order to buy a stated amount of a security at a specified price.

Buy/Stop order—an order to buy at a price above the current market.

Limit order—an order to buy or sell a stated amount of a security at a specified price or at a better price.

Order price—the price at which any limit or stop order is set.

Security—any note, stock, treasury stock, bond, debenture, certificate of interest or participation in any profit-sharing agreement or in any oil, gas, or other mineral royalty or lease, any collateral-trust certificate, preorganization certificate or subscription, transferable share, investment contract, voting-trust certificate, certificate of deposit, for any security, any put, call, straddle, option, or privilege on any security, certificate of deposit, or group or index of securities (including any interest therein or based on the value thereof), or any put, call, straddle, option, or privilege entered into on a national securities exchange relating to foreign currency, or in general, any instrument commonly known as a “security;” or any certificate of interest or participation in, temporary or interim certificate for, receipt for, or warrant or right to subscribe to or purchase, any of the foregoing; but shall not include currency or any note, draft, bill of exchange, or banker's acceptance which has a maturity at the time of issuance of not exceeding nine months, exclusive of days of grace, or any renewal thereof the maturity of which is likewise limited.

Sell/Limit order—an order to sell a stated amount of a security at a specified price or at a better price.

Sell/Stop order—an order to sell at a price below the current market.

Stop-limit order—a stop-limit order is similar to a stop order in that a stop price will activate the order. However, once activated, the stop-limit order becomes a buy limit or sell limit order and can only be executed at a specified price or better.

Stop order—an order to buy at a price above, or sell at a price below, the current market.

Variable percentage—the desired percentage above or below the last sale price for the order price.

Variable points—the desired amount above or below the last sale price for the order price.

### III. SUMMARY OF THE INVENTION

In accordance with one aspect of the present invention, a method for monitoring and modifying securities includes the steps of providing an associated security having an associated purchase price, setting a sell/stop price, setting variable points, setting a time interval, updating an associated last sale price of the associated security after every time interval, adding the variable points to the associated purchase price, the addition rendering a result, subtracting the result from the associated last sale price, the subtraction rendering an adjustment factor, and creating a new sell/stop price if the adjustment factor is greater than zero by subtracting the adjustment factor from the associated last sale price.

In accordance with another aspect of the present invention, a method for monitoring and modifying securities having an associated purchase price and an associated last sale price includes the steps of setting variable points, setting a time interval, updating the associated last sale price after the time interval, adding the variable points to the associated purchase price, the addition rendering a result, subtracting the result from the associated last sale price, the subtraction rendering an adjustment factor, and creating a sell/stop price if the adjustment factor is greater than zero.

In accordance with yet another aspect of the present invention, the method includes the steps of creating a new sell/stop price if the adjustment factor is greater than zero by subtracting the adjustment factor from the associated last sale price, repeating the process after each time interval, and selling the associated security if the last purchase price is equal to or greater than the sell/stop price.

In accordance with one aspect of the present invention, a computer readable medium containing instructions for controlling a computer system to perform a method for monitoring and modifying securities having an associated purchase price and an associated last sale price, the method including the steps of providing an associated security having an associated purchase price, setting a sell/stop price, setting variable points, setting a time interval, updating an associated last sale price of the associated security after every time interval, adding the variable points to the associated purchase price, the addition rendering a result, subtracting the result from the associated last sale price, the subtraction rendering an adjustment factor, and creating a new sell/stop price if the adjustment factor is greater than zero by subtracting the adjustment factor from the associated last sale price.

In accordance with another aspect of the present invention, a computer readable medium containing instructions for controlling a computer system to perform a method for monitoring and modifying securities having an associated purchase price and an associated last sale price, the method including the steps of setting variable points, setting a time interval, updating the associated last sale price after the time interval, adding the variable points to the associated purchase price, the addition rendering a result, subtracting the result from the associated last sale price, the subtraction rendering an adjustment factor, and creating a sell/stop price if the adjustment factor is greater than zero.

In accordance with still another aspect of the present invention, a securities monitoring apparatus includes means for setting variable points, means for setting a time interval, means for updating the associated last sale price after the time interval, means for adding the variable points to the associated purchase price, the addition rendering a result, means for subtracting the result from the associated last sale price, the subtraction rendering an adjustment factor, and means for creating a sell/stop price if the adjustment factor is greater than zero.

In accordance with another aspect of the present invention, the apparatus includes means for creating a new sell/stop price if the adjustment factor is greater than zero by subtracting the adjustment factor from the associated last sale price.

In accordance with another aspect of the present invention, a method for monitoring and modifying securities having an associated last sale price includes the steps of setting variable points, setting a time interval, updating the associated last sale price after the time interval, verifying that the last sale price is greater than the purchase price, and automatically modifying an order price such that the order price is the associated last sale price minus the variable points.

In accordance with another aspect of the present invention the method includes setting a variable percentage and automatically modifying an order price such that the order price is the variable percentage less than the associated last sale price.

Still other benefits and advantages of the invention will become apparent to those skilled in the art upon a reading and understanding of the following detailed specification.

### IV. DESCRIPTION OF THE INVENTION

The inventive process allows the owner of a security to enter variable information about each security contained in the portfolio and then automatically adjust the sell stop point in the event of increases in security prices. This inventive process allows an order price to be automatically updated without any additional input from the owner. In the event of a downturn, the security will automatically sell once the computed stop price has been reached.

The inventive process begins when the owner of the security selects the sell stop option offered by the brokerage firm, normally under the “Sell” category. The owner then fills in the information pertaining to stock symbol, quantity, sell/stop price, variable points, and how often the security owner wishes to compute a new sell/stop price. The following information is also included: the original price at which the security was purchased, an adjustment factor, and the last sale price. The owner of the security then chooses which security, or securities, he wishes to manipulate, as well as the quantity. The owner than chooses the price at which he wishes to sell his security. At this point, the owner of the security chooses the variable points, or how many points below the current price at which he wishes to sell the security. The owner then chooses how often the computer will compute a new sell/stop price.

Once the process has been initiated, and the relevant information has been supplied, every x number of minutes, the computer reads the security symbol in question and moves the last sale price into a “Last Sale Price” field, then adds the purchase price to the variable points, thereby giving a result. The result is subtracted from the last sale price, giving the adjustment factor. If the adjustment factor is greater than zero, then the process creates a new sell/stop by subtracting the adjustment factor from the last sale price. If the adjustment factor is less than, or equal to, zero, the process does nothing. If a new sell/stop number is created, the process will inform the owner of the revised sell/stop number. The invention could also use the previous day's closing price in place of the original price.

### EXAMPLE 1

| | | | | Orig. | Last | Sell | Adj. | | New |
|---|---|---|---|---|---|---|---|---|---|
| Symbol | Quantity | Var. Pts | Min. | Price | Price | Stop | Factor | Result | Sell/Stop |
| XYZ | 100 | 10 | 20 | 100 | 120 | 90 | 10 | 110 | 110 |

### EXAMPLE 2

Another example of how the process could work is that the variable points are subtracted from the last sale price every x minutes. Therefore, the new sell/stop price would always be the number of variable points less than the last sale price, thereby maintaining any gains made. The invention could also include the use of percentages instead of variable points, such that the sell/stop price would always be a certain percentage below the last list price.

The invention is not limited to sell/stop orders, but can be applied to any type of stop or limit order. For example, the invention could be used to adjust an order to buy a security. If the order was set to buy the security when it reached 100, the security was currently at 85, followed by a drop in price to 75, the invention could be used to automatically lower the buy order to 90. The implementation of the computer code necessary for the invention would be well known to one skilled in the art.

The invention has been described with reference to several embodiments. Obviously, modifications and alterations will occur to others upon a reading and understanding of the specification. It is intended by applicant to include all such modifications and alterations insofar as they come within the scope of the appended claims or the equivalents thereof.

Having thus described the invention, it is now claimed:

What is claimed is:

1. A method for monitoring and modifying securities, the method comprising the steps of:
providing an associated security having an associated purchase price;
setting a sell/stop price;
setting variable points;
setting a time interval;
updating an associated last sale price of the associated security after every time interval;
adding the variable points to the associated purchase price, the addition rendering a result;
subtracting the result from the associated last sale price, the subtraction rendering an adjustment factor; and,
creating a new sell/stop price if the adjustment factor is greater than zero by subtracting the adjustment factor from the associated last sale price.

2. A method for monitoring and modifying securities having an associated last sale price, the method comprising the steps of:
setting variable points;
setting a time interval;
updating the associated last sale price after the time interval;
automatically modifying an order price.

3. The method of claim 2, wherein setting variable points and automatically modifying an order price such that the order price is the associated last sale price minus the variable points comprises the steps of:
setting a variable percentage; and,
automatically modifying an order price such that the order price is the variable percentage less than the associated last sale price.

4. A method for monitoring and modifying securities having an associated purchase price and an associated last sale price, the method comprising the steps of:
setting variable points;
setting a time interval;
updating the associated last sale price after the time interval;
adding the variable points to the associated purchase price, the addition rendering a result;
subtracting the result from the associated last sale price, the subtraction rendering an adjustment factor; and,
creating a sell/stop price if the adjustment factor is greater than zero.

5. The method of claim 4, wherein creating a sell/stop price if the adjustment factor is greater than zero comprises the step of:
creating a new sell/stop price if the adjustment factor is greater than zero by subtracting the adjustment factor from the associated last sale price.

6. The method of claim 5, wherein the process is repeated after each time interval.

7. The method of claim 5, wherein the method further comprises the step of:
selling the associated security if the last purchase price is equal to or greater than the sell/stop price.

8. A computer readable medium containing instructions for controlling a computer system to perform a method for monitoring and modifying securities having an associated purchase price and an associated last sale price, the method comprising:
setting variable points;
setting a time interval;
updating the associated last sale price after the time interval;
adding the variable points to the associated purchase price, the addition rendering a result;
subtracting the result from the associated last sale price, the subtraction rendering an adjustment factor; and,
creating a sell/stop price if the adjustment factor is greater than zero.

9. The method of claim 8, wherein creating a sell/stop price if the adjustment factor is greater than zero comprises the step of:
creating a new sell/stop price if the adjustment factor is greater than zero by subtracting the adjustment factor from the associated last sale price.

10. The method of claim 9, wherein the process is repeated after each time interval.

11. The method of claim 10, wherein the method further comprises the step of:
selling the associated security if the last purchase price is equal to or greater than the sell/stop price.

12. A securities monitoring apparatus comprising:
means for setting variable points;
means for setting a time interval;
means for updating the associated last sale price after the time interval;
means for adding the variable points to the associated purchase price, the addition rendering a result;
means for subtracting the result from the associated last sale price, the subtraction rendering an adjustment factor; and,
means for creating a sell/stop price if the adjustment factor is greater than zero.

13. The method of claim 12, wherein means for creating a sell/stop price if the adjustment factor is greater than zero comprises the step of:
means for creating a new sell/stop price if the adjustment factor is greater than zero by subtracting the adjustment factor from the associated last sale price.

14. The method of claim 13, wherein the process is repeated after each time interval.

15. The method of claim 14, wherein the method further comprises the step of:
means for selling the associated security if the last purchase price is equal to or greater than the sell/stop price.
